(19) United States
(12) Patent Application Publication
(10) Pub. No.: US 2016/0238387 A1
(43) Pub. Date: Aug. 18, 2016

(54) OBJECT DESCENT DETECTION SYSTEM AND METHOD THEREOF

(71) Applicant: Kushal Singh, Campbell, CA (US)

(72) Inventor: Kushal Singh, Campbell, CA (US)

(21) Appl. No.: 14/623,849

(22) Filed: Feb. 17, 2015

(51) Int. Cl. G01C 5/00

(52) U.S. Cl. CPC G01C 5/005; G01C 5/00

(57) ABSTRACT

An object descent detection system and method is disclosed herein. The method for detecting whether an object is falling includes determining geopotential heights of the object and actuating a response when a change in geopotential heights occurs.

### TECHNICAL FIELD

This disclosure generally relates to falling objects, and more particularly, to avoiding damage to those objects through accurate geopotential height calculations.

### BACKGROUND

Geometric height, or elevation, can be used to describe a height in which an object is located above a point of reference, for example, sea level. Elevation determinations have been hard to calculate and often times inaccurate. Geopotential height, however, can be a more exact way to determine a time object's vertical coordinate. The geopotential height can be referenced to the Earth's mean sea level which is an adjustment to geometric height. What is needed is an object descent detection system and method thereof that takes advantage of the more accurate geopotential height.

### BRIEF DESCRIPTION

According to one aspect of the present disclosure, a method for detecting whether an object is filling is provided. The method can include determining geopotential heights of the object and actuating a response when a change in geopotential heights occurs.

According to another aspect of the present disclosure, a system is provided. The system can include an object identifying geopotential heights and a global object safety system in communication with the object determining an action based on the geopotential heights.

According to yet another aspect of the present disclosure, an object is provided. The object can include at least one processor and a memory operatively coupled to the processor, the memory storing program instructions that when executed by the processor, causes the processor to perform processes. These processes can include detecting a location of the object through a global positioning system, determining temperature and humidity information for the location from meteorological data, identifying a geometric height of the object, converting the geometric height to geopotential height, calculating a pressure altitude, calculating a density altitude, providing a global object safety system with the geometric height, pressure altitude, and density altitude, receiving a response from the global object safety system, and implementing an action based on the response.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a flow chart illustrating exemplary processes for detecting an object descent and providing actions thereon in accordance with one aspect of the present disclosure;

FIG. 2 depicts illustrative meteorological data for determining geopotential heights in accordance with one aspect of the present disclosure;

FIG. 3 illustrates a Global Object Safety System GOSS) in accordance with one aspect of the present disclosure;

FIG. 4 is an illustrative block diagram showing exemplary components for detecting a phone drop in accordance with one aspect of the present disclosure; and

FIG. 5 is an illustrative block diagram showing exemplary components for detecting an airplane drop in accordance with one aspect of the present disclosure.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others.

“Computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point to-point system, a circuit switching system, a packet switching system, among others.

A “disk,” as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “database,” as used herein can refer to table, a set of tables, a set of data stores and/or methods for accessing and/or manipulating those data stores. Some databases can be incorporated with a disk as defined above.

A “memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection,” or a connection by which entities are “operably connected,” is one in which signals, physical communications, and/or logical communications can be sent and/or received. An operable connection can include a wireless interface, a physical interface, a data interface, and/or an electrical interface.

A “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “server”, as used herein, is a computer or program that responds to commands from a client through the Internet or other network. A server program on a computer in a distributed network can handle business logic between users and backend business applications or data bases. Servers can provide transaction management, failure and load balancing. A server can be viewed as part of a three tier application consistent of a front end GUI server such as an HTTP server, an application server and a back end database and transaction server. A server may contain data or program files. The server may connect with databases that are either local or remote from the server.

Generally described, the object descent detection system discussed herein is directed to determining whether an object is descending and providing an action based on that determination. In one embodiment, the object descent detection system can have a global positioning system that can accurately determine the object's location in terms of latitude and longitude. By knowing its location, the object descent detection system can determine the object's current temperature and humidity through meteorological data. The global positioning system can provide geometric height which can be converted to geopotential height. Actions can be taken based on changes to the geopotential height of the object.

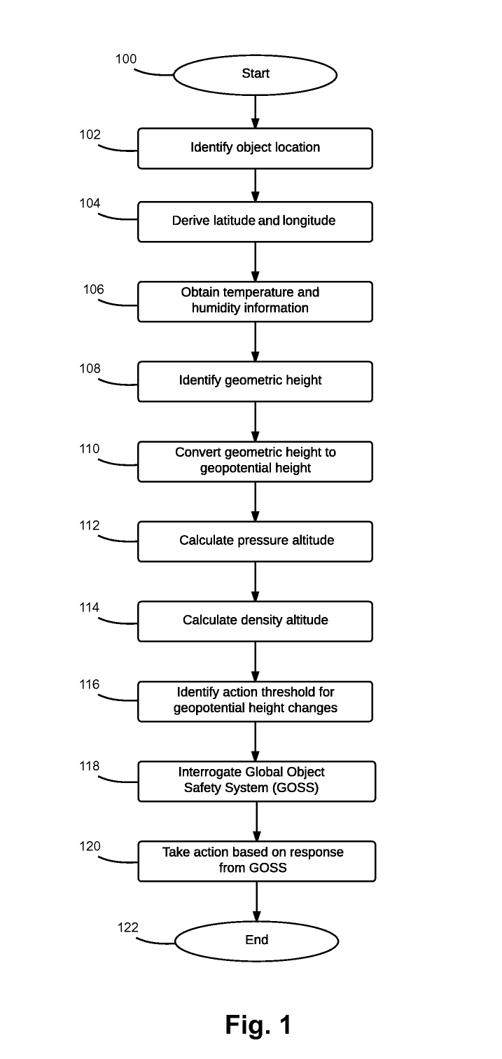

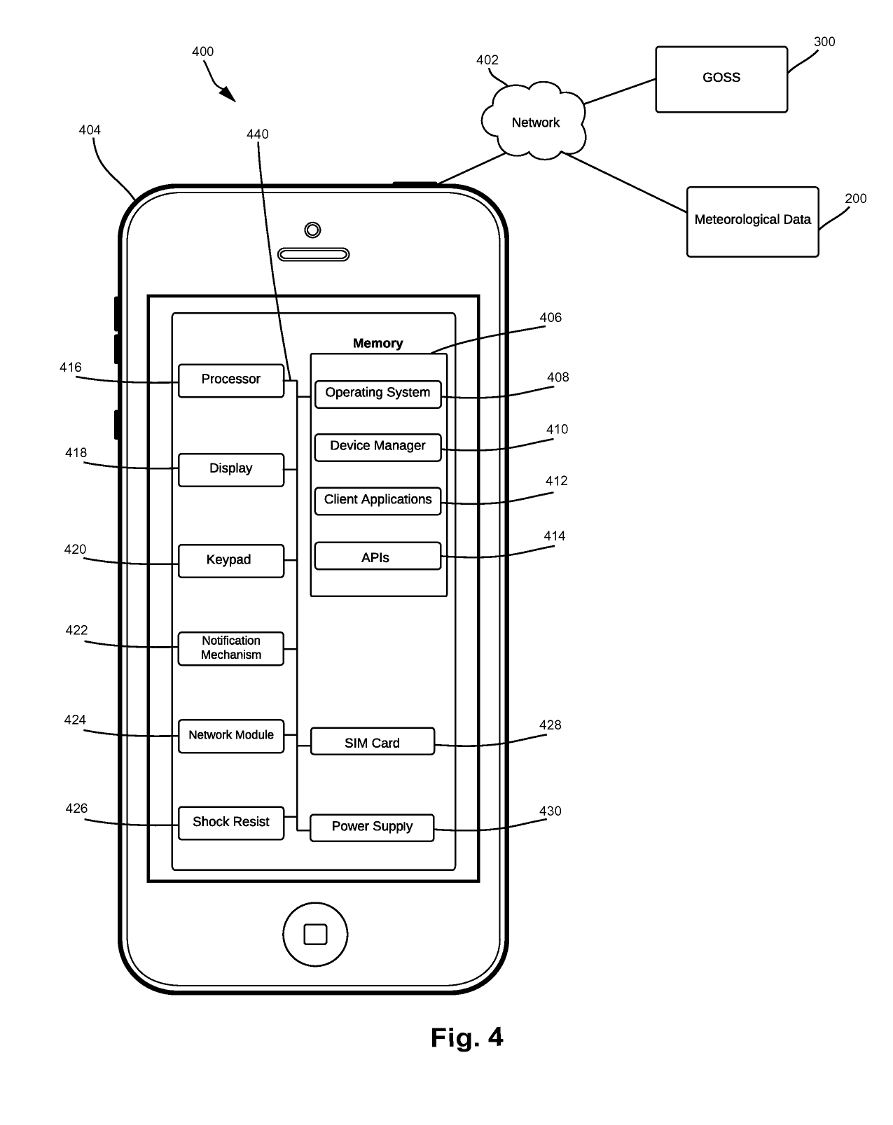

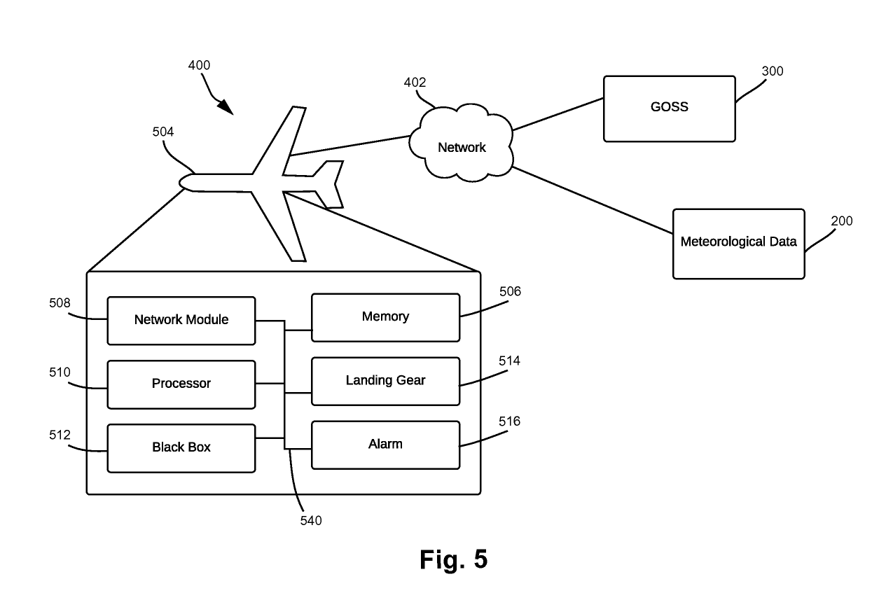

Advantageously, the purpose of the object descent detection system can eliminate the inaccuracies within geometric heights. The precision of pressure, temperature, and humidity derived from the global positioning system data can decrease towards the ground. It is therefore preferable, reliable, and more robust to determine the geopotential height from the geometric height. With reference to the FIGURES, FIGS. 1 through 3 depict an exemplary method for determining changes in geopotential heights of an object and providing actions thereon. FIG. 4 depicts a smartphone as the object for executing an action when dropped, while FIG. 5 shows an airplane.

When an object falls, its altitude relative to a ground surface and sea level can change. The ground surface can be the reference surface to which altitude measurement changes are tracked. The relationship between pressure and altitude can be logarithmic. Pressure can decrease with altitude in earth's atmosphere. An instrument such as an altimeter can be used to measure the altitude above the reference surface level. This is called the geometric height, elevation above mean sea level or the reference surface. Geopotential height can approximate geometric height. The two are typically not the same. Geopotential height can be a function of geometric height and gravity. As such, by taking an object's geopotential height, the object descent detection system disclosed herein provides a more accurate method for calculating changes in height which can correlate to many different actions in a variety of objects.

While the object will be described using examples of a phone and airplane other types of objects can be realized for use with the object descent detection system and method and is not limited to such. The object can be, for example, a phone, tablet, laptop, compact disk player, music player, game console, camera, and remote control. Typically, objects susceptible to damage by dropping on a surface from certain heights are embodied by this disclosure. In one embodiment of this disclosure, the system can help locate lost, stolen, or misplaced objects identified by triggering a signal to a central control system when an object is dropped.

Turning now to FIG. 1, a flow chart illustrating exemplary processes for detecting an object descent and providing actions thereon in accordance with one aspect of the present disclosure is provided. As will be shown, the processes can leverage scientific principles that define the relation between: height, pressure, gravity, mass, speed, and temperature. Through these, a drop of an object can be detected to automatically launch pre-set operations to either prevent damage to the falling object or help locate the damaged object if prevention of fall cannot be avoided. The processes can start at block 100.

At block 102, the object descent detection system can identify its location through a global positioning system receiver. Global positioning systems can work through a set of satellites that send location and timing data to the object. It can provide a location on a map as well as elevation. At block 104, the object descent detection system can derive latitude and longitude information from the determined location. While latitude and longitude are primarily described herein, other types of location information can be used as reference points. The object descent detection system, at block 106, can obtain current temperature and humidity information through meteorological data which can be accessed through a network connection.

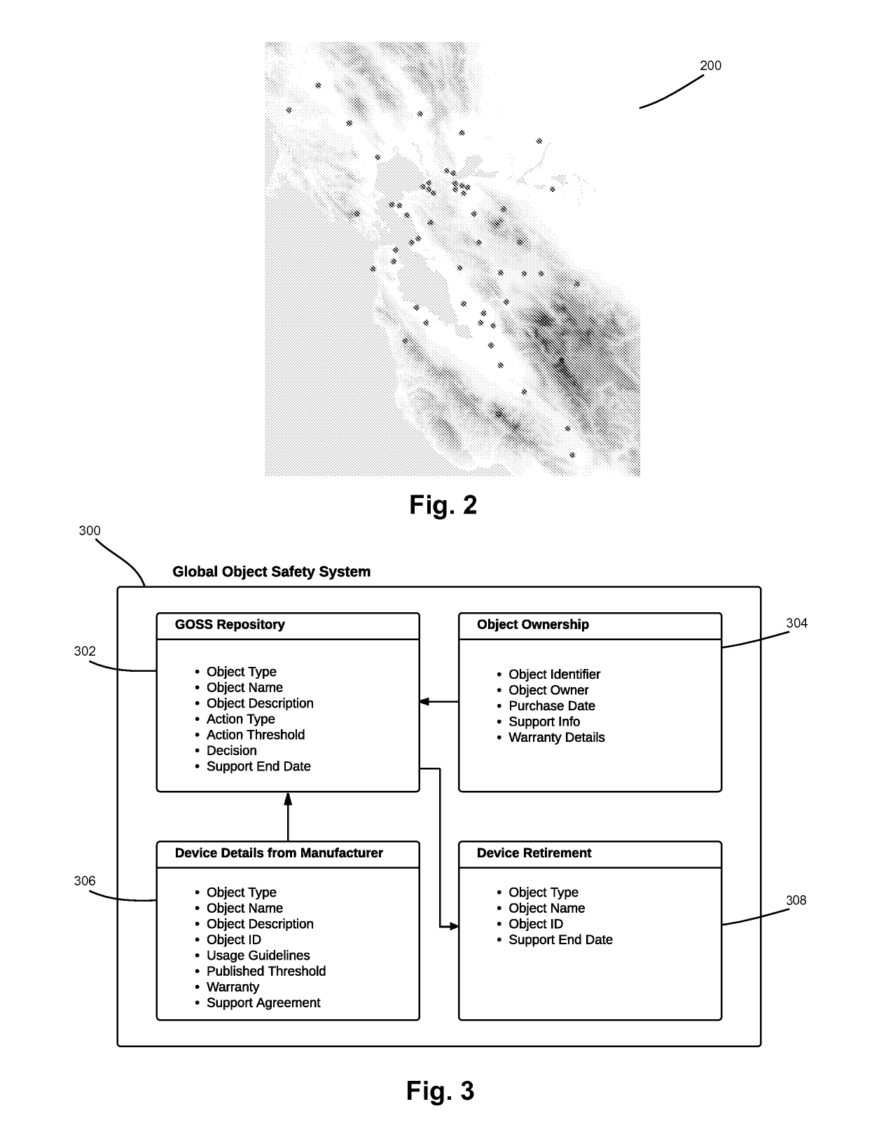

Meteorological data 200, as shown in FIG. 2, can be obtained from a number of sources. The previously determined longitude and latitude can be used. The meteorological data 200 can provide information such as wind, temperature, air density and other pertinent data that affects geopotential height determinations. There are a number of points within the meteorological data 200 that are used to capture the information. The points can represent stations on the ground or in some instances, in the air. This information can be stored in a server and can be accessed by the object descent detection system wirelessly. The meteorological data 200 can be updated consistently through the stations.

At block 108, the object descent detection system can identify the geometric height of the object through the global positioning system receiver described earlier. By using a single global positioning system receiver on the object, components can be reduced. The object descent detection system, at block 110, can convert the geometric height to geopotential height. Using the formula below, the geopotential height can be defined at an elevation of h as:

Φ(h)=∫₀^{h}g(Ø, z)dz

where g(Ø,z) is acceleration due to gravity, Ø is latitude, and z is the geometric elevation. As such, geopotential height can be defined as the gravitational potential energy per unit mass at the elevation h.

The geopotential height can be defined as:

$${Z}_{g} ( h ) = \frac{Φ ( h )}{{g}_{0}}$$

which normalizes the geopotential to g₀, the standard gravity at mean sea level. Using geopotential height as a function of pressure can eliminate the need for using air density from the equation.

At block 112, the object descent detection system can calculate pressure altitude, which is a type of geopotential height. The gravitational potential energy (Φ) of a unit mass can be simply the integral from mean sea level (z=0 meters) to the height of the mass (z=Z). The gravitational potential energy can be provided by the following equation:

Φ=∫₀^{z}Y(z, ⊖)dz

where Y(z,⊖) is the normal gravity above the geoid. The gravitational potential energy can be a function of both geometric altitude (z) and geodetic latitude (⊖). Note that normal gravity can be measured by a plumb line and it can include contributions from both gravitational and centrifugal forces. While the geopotential (potential energy per unit mass) can be useful for atmospheric dynamics studies as it is a convenient way to compare meteorological data from different locations, it would be more convenient to be expressed as a height above the geoid. To this end, the geopotential (Φ) can be divided by the normal gravity (Y45) at a latitude of 45 degrees to obtain the geopotential height scale:

$$H ( Z , θ ) = \frac{Φ ( Z , θ )}{ϒ 45} = \frac{1}{ϒ 45} {\int }_{0}^{Z} ϒ ( Z , θ ) d z$$

A latitude of 45 degrees can be chosen because it was the latitude used by the World Meteorological Organization (WMO) to calibrate barometers. Since surface gravity is greatest at the poles and least at the equator, this “splits the difference” and results in geopotential height being close to geometric height at mid-latitudes. The difference between geometric altitude and geopotential height can be significant (˜120 meters) near the equator. Also, since Y(z,⊖) decreases with height, except near the poles, the geopotential height can generally be less than the geometric height. The value for Y45 equals 9.80665 m/s2.

At block 114, the object descent detection system can calculate density altitude, which is another type of geopotential height. This can be the pressure altitude corrected for temperature, pressure, and humidity differences from the International Standard Atmosphere. Density altitude can be very different from the pressure altitude under very hot or cold conditions. The density altitude z is given by the expression:

$$z = \frac{= {T}_{0}}{LR} [ \begin{matrix} & - \frac{LR \cdot {R}_{d}}{- 1000 \cdot ϒ 45 + LR \cdot {R}_{d}} \\ 1 - \frac{p}{{p}_{0}} & \end{matrix} ]$$

where Tₒ equals 288.15 K, LR equals −6.5 K/km, p₀ equals 1.2250 kg/m3, R_{d} equals 287.0531 J/kg K, and Y equals 9.80665 m/s2. The factor of 1000 can be used to convert kilometers to meter to have consistent MKS units.

At block 116, the object descent detection system can identify an action threshold for the determined geopotential height changes. The threshold can be dependent on the type of object that the object descent detection system is placed in. For example, a smaller drop for a smartphone is more relevant than a minor descent for an airplane. When the smartphone is dropped, for example, six inches, the threshold value can be met.

The thresholds can be established in memory of the object. Alternatively, a remote server can provide this information regarding the threshold. When the action threshold is met, the object descent detection system, at block 118, can interrogate a Global Object Safety System (GOSS). FIG. 3 illustrates GOSS 300 in accordance with one aspect of the present disclosure. GOSS 300 can be a server where information is setup and stored about objects. Within GOSS 300, a Repository 302 can be established. The Repository 302 can include an Object Type, Object Name, Object Description, Action Type, Action Threshold, Decision, and Support End Date. Each of these attributes can define the object.

Additional information for GOSS 300 can be tied to Object Ownership 304. Object Ownership 304 can include an Object Identifier, Object Owner, Purchase Date, Support Info and Warranty Details. Each of these attributes within Object Ownership 304 can relate to the specific details of an actual owner of the object.

Device Details 306 within GOSS 300 from the manufacturer can also be provided. These attributes can be used to provide additional information and more specifically details related to the manufacturing of the device. The attributes for Device Details 306 can include Object Type, Object Name, Object Description, Object ID, Usage Guidelines, Published Threshold, Warranty and Support Agreement.

GOSS 300 can include Device Retirement 308. Device Retirement 308 can relate to information about whether the object has been inactive or not in use. Attributes within Device Retirement 308 can include Object Type, Object Name, Object ID, and Support End Date.

Continuing with FIG. 1, and after GOSS 300 has been interrogated, at block 120, the object descent detection system can take action based on the response from GOSS 300. In one embodiment, actions can be stored locally on the object itself without the use of GOSS 300. Based on the response from GOSS 300, a variety of actions can be executed, which will be elaborated below. At block 122, the object descent detection system can end the processes.

As provided in the flow chart above, a number of advantages can be realized by taking the geopotential heights of an object and actuating a response. The object descent detection system can analyze three data sets, temperature, pressure, and height, to facilitate in making decisions for falling objects, as opposed to treating each individual measurement as its own distinct entity. The system has no limitation of a surface whether air, ground or water, and is intended to work in any part of planet earth that is covered by satellites. Typically, the system is fault tolerant as it uses satellite based geo-stationary global positioning system information and uses a real-time decision sophisticated cloud-based repository system.

Turning now to FIG. 4, an illustrative block diagram showing exemplary components for detecting a phone drop in accordance with one aspect of the present disclosure is provided. The environment 400 for detecting the phone drop and executing an action can include, but is not limited to, a network 402, phone 404, server storing GOSS 300 and server storing meteorological data 200. Each of the components can connect through computer communications. Fewer or additional components can be provided and is not limited to those shown within the environment 400.

The communications can be provided through different types of networks 402. These networks 402 can include, but are not limited to, a local area network (LAN), wide area network (WAN), personal area network (PAN), campus area network (CAN), metropolitan area network (MAN), global area network (GAN) or combination thereof. Such networking environments are commonplace in office networks, enterprise-wide computer networks, intranets and the Internet, which are all types of networks. The network 402 used can depend on the device connecting with the environment 400.

The phone 404, within the environment 400, can be a smartphone, cellular phone, or the like. Alternatively, other types of devices can be used as will become apparent from the provided discussion which can include pagers, tablets, desktops, laptops, remote controls, or other types of personal devices. In typical embodiments, the phone 404 can have a memory 406, processor 416, display 418, keypad 420, notification mechanism 422, network module 424 and power supply 430. The components in the phone 404 can be connected through a bus 440. The memory 406 generally includes both volatile memory (e.g., RAM) and non-volatile memory (e.g., ROM, Flash Memory, or the like). The non-volatile portion of the memory 406 can be used to store persistent information which should not be lost when the phone 404 is powered down. The phone 404 can include an operating system (OS) 408, such as Windows CE™ or Windows Mobile™ available from Microsoft Corporation, Android™ from Google, or other OS. The OS 408 can reside in the memory 406 and be executed on the processor 416.

The memory 406 can also include one or more device managers 410 for interacting with one or more I/O devices. The device managers 410 can be software installed on the phone 404. A device manager 410 can correspond to each I/O device. In addition to the device manager 410, client applications 412 can be loaded into memory 406 and run on or in association with the operating system 408. The object descent detection system can reside in memory 406 as a client application 412, or alternatively, within the OS 408. The object descent detection system can also run in other locations of memory 406.

The memory 406 can also include a collection of one or more APIs 414 for facilitating wireless communication between the phone 404 and one or more remote I/O devices. The APIs 414 can be invoked by the object descent detection system to interact with GOSS 300 and obtain meteorological data 200. In this manner, the phone 404 is able to take advantage of services or functionalities of the one or more remote I/O devices.

The display 418 of the phone 404 can be a liquid crystal display (LCD), or any other type of display commonly used in phones 404. The display 418 can be touch-sensitive, and can act as an input device. The keypad 420 can be a push button numeric dialing pad (such as on a typical telephone), a multi-key keyboard (such as a conventional keyboard), or any other device for inputting textual data. The phone 404 can include one or more audio, visual, and/or vibratory notification mechanisms 422.

A network module 424 can be provided within the phone 404. The network module 424 can provide wireless or wireline access to the network 402. Communications can be provided by the network module 424 to the GOSS data 300 and meteorological data 200. The GOSS data 300 and meteorological data 200 can be provided through servers who communicate with the phone 404 over the network 402 and specifically, the network module 424 of the phone 404.

The phone 404 can also include a power supply 430, which can be implemented as one or more batteries, fuel cells, or other sources of electrical power. The power supply 430 might further include an external power source, such as an AC adapter or a powered docking cradle that supplements or recharges the batteries.

Through the object descent detection system, the phone 404 can execute the processes provided in FIG. 1 to determine geopotential height changes. These geopotential height changes can be used to activate the shock resistance 426 on the phone 404. The shock resistance 426 component can activate padding (for example, an inflatable balloon) on the phone 404 that can protect the components including the touchscreen display 418 from being damaged. The shock resistance 426 can be replaceable within the phone 404 or reusable.

In one embodiment, when geopotential height changes are detected by the object descent detection system, memory can be provided to the SIM card 428. The SIM card 428, for instance, can be used to capture last screen shot data or save any files that are currently opened. The SIM card 428 can then be accessed by another device in the event that the phone 404 no longer works or is operable. The power supply 430 of the phone 404 can in addition to, or separately therefrom, be turned off. This can prevent further damage to the phone 404 and remove unwanted power to components within the device that are damaged. In some objects, this can prevent fires, for example, in a vehicle.

Through the object descent detection system, a number of actions can be taken on the phone 404. The phone 404 can provide the ability to trigger a save in potential loss of data due to an unexpected change in height, temperature, or pressure. The phone 404 can also be shut off through the object descent detection system due to an unexpected change in height, temperature, or pressure. In addition, the phone 404 has the ability to trigger a shock resistance 426 due to an unexpected change in height, temperature or pressure. While not shown in FIG. 4, the object descent detection system can provide the ability for the phone 404 to activate a suction grip which adheres to a user's hand due to an unexpected change in height, temperature, or pressure.

In one embodiment, the object descent detection system can be used to locate the phone 404. For example, if the phone 404 is dropped at a rapid pace, an alarm can go off in the phone 404 that would indicate that it has been lost. Other embodiments can be provided, for example, if the phone 404 rises up quickly, the phone 404 can go into airplane mode automatically.

A variety of objects can be used with the object descent detection system and method thereof and is not limited to the phone 404. FIG. 5 is an illustrative block diagram showing exemplary components for detecting an airplane 504 drop in accordance with one aspect of the present disclosure. The object descent detection system for the airplane 504 can use a similar, or the same environment 400, presented earlier. For instance, the plane 504 can obtain GOSS data 300 and meteorological data 200 through the network 402 on each of their respective servers.

The plane 504 can include a network module 508, processor 510, black box 512, memory 506, landing gear mechanism 514, and alarm 516 connected through a bus 540. The network module 508 can be used by the plane 504 to communicate with the network 402. The object descent detection system on the plane 504 can be placed into memory 506 of the plane and be executed by the processor 510 similar to the phone 404 described previously.

Through the processes described in FIG. 1, the object descent detection system can be used to detect changes in geopotential heights to provide an action. These actions can include, but are not limited to, the ability to activate a landing gear mechanism 514 due to an unexpected change in height, temperature, or pressure. When a change occurs through the geopotential height determinations, the plane 504 could automatically activate the landing gear mechanism 514 without the need for pilot intervention. The height changes would occur lower to the ground.

The plane 504 can also, or separately therefrom, provide the ability to automatically raise an alarm 516 by detecting a sudden change in height, temperature, or pressure. This can include sending data offboard through the network 402 to a monitoring agency. Changes in height, temperature, or pressure can indicate issues within the plane 504. Agencies can then more closely monitor the plane after the alarm 516 is raised. In addition, the change in geopotential heights can cause the airplane 504 to save additional data into the black box 512, data that normally would not be saved.

In one embodiment, the plane 504 can provide the ability to trigger a search and find operation by detecting a sudden change in height, temperature, or pressure provided by the object descent detection system. This activity can be coordinated with the airline carrier and/or additional agencies involved in a potential rescue operation. This could reduce the time to find survivors in the event of a disaster.

In each of the embodiments described above, the drop in the plane 504 typically is greater than the drop in the phone 404 to activate the modules. The central repository GOSS 300 can be used to determine the threshold to actuate a response. Alternatively, this threshold can be placed on the plane 504 itself. Other features for the plane can be activated after a change in geopotential heights occur and can include, but are not limited to, activation of oxygen masks, ejection of the black box 512 such that it can be found more easily, sounding emergencies within the plane 504 for passenger bracing, and the like.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A method for detecting whether an object is falling comprising:
determining geopotential heights of the object; and
actuating a response when a change in geopotential heights occurs.

2. The method of claim 1, wherein determining geopotential heights of the objects comprises converting geometric height measurements into geopotential heights.

3. The method of claim 1, wherein determining geopotential heights of the objects comprises detecting a location, temperature and pressure.

4. The method of claim 3, wherein detecting the location comprises receiving global positioning system data.

5. The method of claim 3, wherein determining temperature and pressure of the object comprises receiving meteorological data based on the location.

6. The method of claim 1, wherein actuating the response when the change in geopotential heights occurs comprises retrieving the response from a cloud-based repository.

7. The method of claim 1, wherein actuating the response when the change in geopotential heights occurs comprises saving data.

8. The method of claim 1, wherein actuating the response when the change in geopotential heights occurs comprises shutting down.

9. The method of claim 1, wherein actuating the response when the change in geopotential heights occurs comprises providing a shock resistance.

10. The method of claim 1, wherein actuating the response when the change in geopotential heights occurs comprises activating a suction grip.

11. The method of claim 1, wherein actuating the response when the change in geopotential heights occurs comprises activating a landing gear.

12. The method of claim 1, wherein actuating the response when the change in geopotential heights occurs comprises activating an alarm.

13. The method of claim 1, wherein actuating the response when the change in geopotential heights occurs comprises triggering a search and find operation.

14. A system comprising:
an object identifying geopotential heights; and
a global object safety system in communication with the object determining an action based on the geopotential heights.

15. The system of claim 14, wherein the object identifies geopotential heights by:
detecting a location of the object through a global positioning system;
determining temperature and humidity information of the location from meteorological data;
identifying a geometric height of the object;
converting the geometric height to geopotential height;
calculating pressure altitude; and
calculating density altitude;

16. The system of claim 14, wherein the object is at least one of a phone, tablet, laptop, music player, game console, camera, and remote control.

17. The system of claim 14, wherein the object is an airplane.

18. An object comprising:
at least one processor; and
a memory operatively coupled to the processor, the memory storing program instructions that when executed by the processor, causes the processor to:
detect a location of the object through a global positioning system;
determine temperature and humidity information for the location from meteorological data;
identify a geometric height of the object;
convert the geometric height to geopotential height;
calculate a pressure altitude;
calculate a density altitude;
provide a global object safety system with the geometric height, pressure altitude, and density altitude;
receive a response from the global object safety system;
implement an action based on the response.

19. The object of claim 18, wherein implementing the action based on the response comprises at least one of saving data, shutting down, resisting shock, and activating suction.

20. The object of claim 18, wherein implementing the action based on the response comprises at least one of activating landing gear, raising an alarm, and triggering a search and find operation.
